(19) United States
(12) Patent Application Publication
(10) Pub. No.: US 2015/0317627 A1
(43) Pub. Date: Nov. 5, 2015

(54) METHOD AND SYSTEM FOR PREVENTING FRAUD

(71) Applicant: BioPrint Security, Ltd., Rockwall, TX (US)

(72) Inventor: Kathy Ann Howe, Rockwall, TX (US)

(21) Appl. No.: 14/267,180

(22) Filed: May 1, 2014

(51) Int. Cl. G06Q 20/38

(52) U.S. Cl. CPC G06Q 20/3821; G06Q 2220/00

(57) ABSTRACT

Disclosed herein are methods and systems of preventing fraud during a financial transaction. A consumer can subscribe, enter, and store their personal and business credit and debit card information, account numbers, pin numbers, logins, and passwords on a secure website. The consumer also can upload biometric data, such as a thumbprint or fingerprint, to the security system using a smart phone or tablet. The thumbprint and fingerprints act as the consumer's identifier when using the service and system. At the point of sale, the consumer places their thumb or finger on the biometric reader. The purchase amount is sent to the security system after the consumer chooses a credit or debit card. The security system sends a request for payment to the credit card company if the thumbprint matches. The credit card company determines whether to approve the transaction and if so, remits payment to the security system. The security system then remits the payment to the vendor.

### FIELD

The disclosure relates generally to security for financial transactions. The disclosure specifically relates to biometric security for financial transactions.

### BACKGROUND

A current method of payment is the use of credit cards and/or debit cards. Unfortunately, the information from these cards enters the vendor's system when the card is used. The credit card or debit card information can be stolen if there is a security breach in the vendor's system. Consumers face uncertainty as to which vendor will face a security breach next. In addition, theft of the actual card itself leads to financial loss and loss of time for the consumer and credit card company.

It would therefore be advantageous to have a payment method that does not require an individual to carry credit cards, debit cards, or cash and does not require sensitive information such as account numbers and personal identification numbers transmitted through a vendor's system or entered into a terminal in a public location such as a vendor.

### SUMMARY

An embodiment of the disclosure is a system to prevent fraud comprising a secure website accessible by a consumer to prepare a profile comprising biometric data; a vendor computer system capable of transmitting the amount of a purchase to the consumer; a biometric reader in communication with the vendor computer system, wherein the consumer provides biometric data to institute payment; a computer network capable of transmitting a signal from the biometric reader to the security system; a computer capable of comparing the biometric data present in the profile to the biometric data transmitted in the signal; a computer network capable of transmitting a signal from the security system to a financial institution; a computer network capable of transmitting a signal comprising payment for the transaction from the financial institution to the security system; and a computer network capable of transmitting a signal comprising payment for the transaction from the security system to the vendor computer system. In an embodiment, the biometric data is a fingerprint. In another embodiment, the vendor computer system comprises one or more computers. In yet another embodiment, the signal comprises at least one selected from the group consisting of biometric data and amount of purchase. In an embodiment, the financial institution is a credit card company. In another embodiment, the financial institution is a bank. In an embodiment, the vendor computer system comprises a point-of-sale terminal. In another embodiment, wherein the vendor computer system comprises an automatic teller machine. In yet another embodiment, the profile includes credit card numbers. In an embodiment, the biometric reader is heat sensitive.

An embodiment of the disclosure is a method to prevent fraud comprising preparing a profile on a secure web site, wherein the profile includes biometric data; attempting to obtain goods or money from a vendor; transmitting the amount of goods or money to be obtained from a vendor computer system to a biometric reader; placing a body part comprising the biometric data in range of the biometric reader; transmitting the biometric data to a security system; transmitting a signal comprising biometric data from the security system to a financial institution; comparing of the signal biometric data to the biometric data present in the profile; transmitting a signal from the financial institution to the security system comprising payment for the transaction; and transmitting a signal from the security system to the vendor computer system comprising payment. In an embodiment, the biometric data is a fingerprint. In another embodiment, the vendor computer system comprises one or more computers. In yet another embodiment, the financial institution is a credit card company. In an embodiment, the financial institution is a bank. In another embodiment, the vendor computer system includes a point-of-sale terminal. In an embodiment, the vendor computer system comprises an automatic teller machine. In another embodiment, the profile includes credit card numbers. In yet another embodiment, the biometric reader is heat sensitive.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 depicts a flow chart of consumer use of the security system;

FIG. 2 depicts a flow chart of vendor use of the security system;

FIG. 3 depicts a flow chart of a financial institution use of the security system;

FIG. 4 depicts a diagram of a possible transaction using the security system.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure can be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

As used herein, the term “financial institution” means and refers to a credit card company, debit card company, bank, or individual or company which provides a financial transaction.

As used herein, the term “secure website” means and refers to the web location at which the consumer creates a profile.

As used herein, the term “security system” means and refers to all software and electronic infrastructure, including the secure website and computer networks utilized in sending and receiving the biometric data, requesting and receiving payment, and keeping records of transactions.

As used herein, the term “point of sale” means and refers to the time at which the customer makes a payment to the vendor in exchange for the goods or services.

As used herein, the term “vendor” means and refers to a party that is offering goods and/or services.

A biometric method of payment through a secure intermediary website eliminates the need to use credit or debit cards at the point of sale, eliminating the possibility of fraudulent credit/debit card use by employees of the vendor or by hackers who obtain access to a vendor's computer system.

In an embodiment, the payment method does not require an individual to carry credit cards, debit cards, or cash and does not require sensitive information such as account numbers and personal identification numbers to be transmitted through a vendor's computer system.

In an embodiment, a secure website is created for a consumer to subscribe, enter, and store their personal and business credit and debit card information, account numbers, pin numbers, logins, and passwords. After the consumer has created the account, the consumer will upload their thumbprints and fingerprints using a smart phone or tablet. The thumbprint and fingerprints will act as the consumer's identifier when using the service. The consumer will also have a login with the secure website to update or add information to the account and to review transactions. In an embodiment, the consumer's fingerprint can act as a password for the secure website. In an embodiment, the secure website will be built by a programmer. In an embodiment, the security system will contract with a firm that provides security services. In an embodiment, existing software can be used for biometric scanning. In another embodiment, software will be designed for biometric scanning.

In an embodiment, a relationship will be established between the security system and credit card companies and financial institutions to allow the security system to process payments on behalf of the consumer. Currently, vendors contract with credit card companies and agree to certain fees which the consumer does not pay or see in the transaction. In an embodiment, the fees can be paid by the vendor and/or passed through by the security system. The system should be appealing to credit card companies and banks because when fraud is identified in financial companies, the company usually waives the fraudulent charges for the consumer. In most cases the fraudulent amounts are charged off and the loss is suffered by the bank or credit card company. The security system will save countless hours of work by credit card company employees investigating fraudulent charges.

A relationship and link to vendors is established. In an embodiment, equipment including, but not limited to, a biometric reader can be provided for use by the consumer. In an embodiment, a program would be required by the security system to allow the biometric reader to pick up the amount of the sale and credit the vendor. In an embodiment, the biometric reader could be an iPad, iPhone, or Android device and include no other programs or applications other than the security system. In an embodiment, the biometric reader can be any device capable of scanning the biometric data. In an embodiment, the biometric system would work similar to the vendor's current system but without having to provide credit card information or pin numbers to a vendor.

The security system will be beneficial for vendors because vendors would not need to be concerned about theft of consumer credit card information and identity theft through their company and credit card readers. In an embodiment, the vendor does not receive the consumer's credit/debit card information and therefore the credit/debit card information is not present on the vendor's system to be stolen. This benefits the vendor by eliminating reputation and financial risks due to the vendor's system being compromised by their employees or hackers.

In an embodiment, the consumer can provide one scan of a finger and/or thumb. In an embodiment, the consumer can provide multiple scans of each finger and/or thumb. In an embodiment, the consumer can provide a scan of multiple fingers and/or thumbs. In an embodiment, a consumer can provide a combination of biometric data. In an embodiment, the biometric data can be a fingerprint and facial scan. In an embodiment, the vendor can have one or more sensors for providing biometric data. In an embodiment, a consumer can save multiple types of biometric data in his/her profile so that the information is present regardless of which sensor system a vendor uses. In an embodiment, the security system is capable of comparing multiple types of biometric data to the biometric data on file and approving a transaction based on a match of the biometric data. In an embodiment, additional security can be added by requiring the prints of multiple fingers or multiple types of biometric data to initiate the transaction.

In an embodiment, the biometric reader scans a fingerprint as it is placed on the screen. In an embodiment, the biometric reader recognizes changes in electrical charge at a particular point in the screen. In an embodiment, the biometric reader scans a fingerprint as the finger is moved across a sensor. In an embodiment, the biometric reader is heat sensitive. In an embodiment, the biometric reader can be a touch-less fingerprint sensor. In an embodiment, the biometric reader is the fingerprint scanner on a smart phone or tablet.

In an embodiment, fingerprint matching algorithms can be utilized. In an embodiment, the algorithms include but are not limited to image correlation, phase matching, skeleton matching, and minutiae matching.

In an embodiment, thumbprints and fingerprints can be matched to the print on file by an automated system. There is a unique pattern of ridges and valleys on our fingers and thumbs. The papillary ridges on our fingers are called friction ridges. Palms and soles also contain a unique pattern of ridges and valleys. In an embodiment, when the consumer prepares a profile on the secure website, he/she scans in his/her fingerprint using a device such as a smart phone or tablet. Various points on the digital image of the fingerprint are identified. These points are called minutia points and are located where friction ridges end abruptly or branch. In an embodiment, when the consumer scans their fingerprint at a vendor, the minutia points on the print are identified. The minutia points on the print scanned at the vendor are compared to the minutia prints on file. The number of minutia points that align are determined and compared to the required number of alignments for a match.

A biometric reader can also be present on service station pumps for fuel purchases to reduce or eliminate theft from card readers. In an embodiment, the biometric reader can be present at automated teller machines, eliminating the need to enter a pin number.

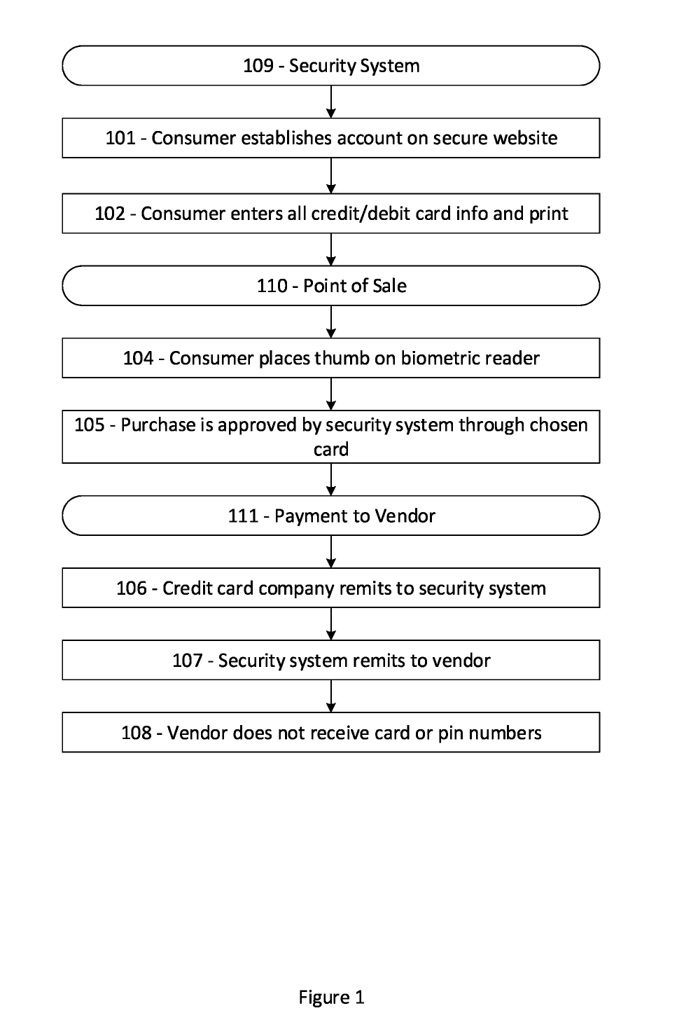

As depicted in FIG. 1, as part of the security system 109, the consumer establishes an account on the secure website 101 and enters some or all credit and debit card information 102 and a thumbprint or fingerprint 103 At the point of sale 110, the consumer places their thumb or finger on the biometric reader 104. The purchase is approved by the security system by comparing the biometric data and requesting payment from the chosen credit or debit card 105. To achieve payment to the vendor 111, after the credit card company approves the charge, it remits payment to the security system 106. The security system then remits the payment to the vendor 107. The vendor never receives the credit card number or pin number 108.

In an embodiment, a consumer can pay bills using the security system. In an embodiment, the bills include but are not limited to utility bills and automobile payments.

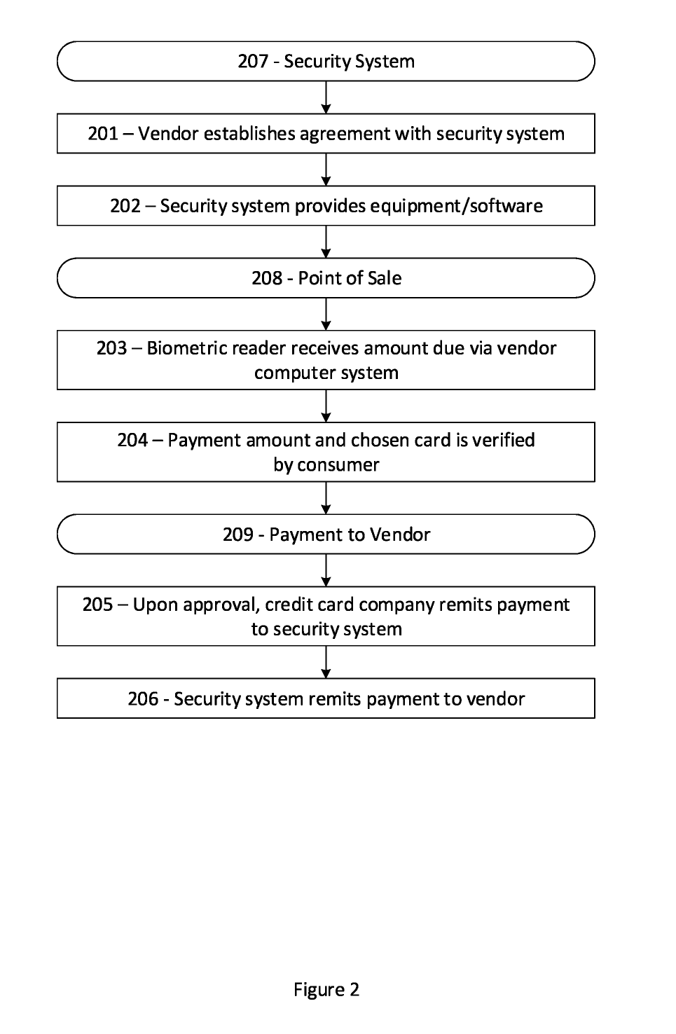

As depicted in FIG. 2, to use the security system 207, the vendor establishes an agreement with the security system 201. The individual or company offering the security system can provide equipment, such as an iPad and software, to the vendor 202. At the point of sale 208, the biometric reader receives the dollar amount of the purchase via the vendor computer system 203. The consumer then selects the credit or debit card to use for payment and verifies the amount of the charge 204. To achieve payment to the vendor 209, upon approval of the charge by the credit or debit card company, after approval by the security system, the credit or debit card company remits payment to the security system 205. The security system then remits the payment to the vendor 206.

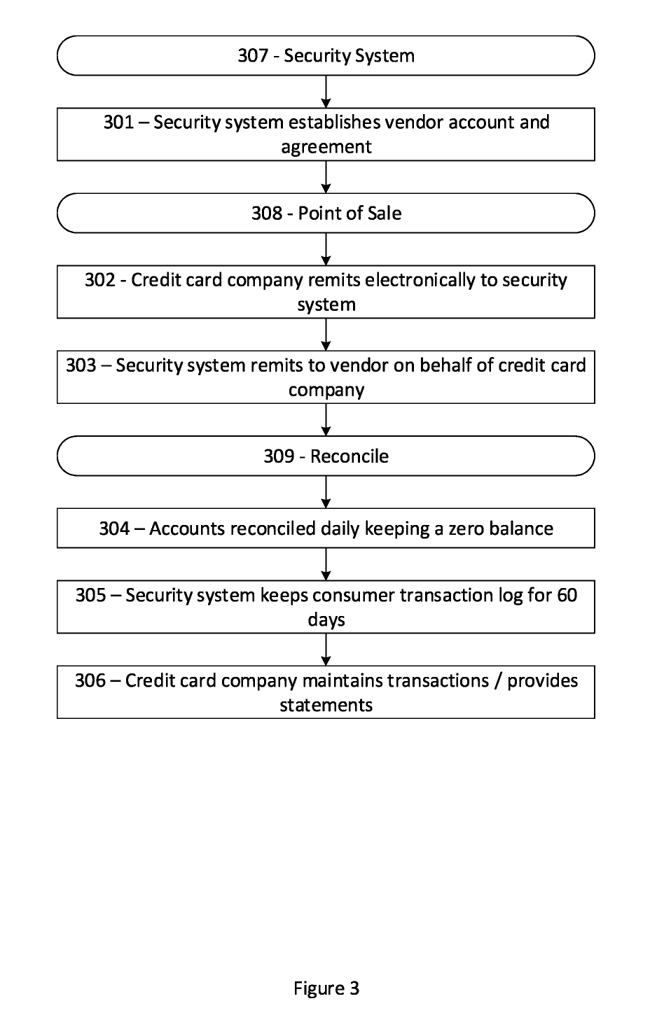

As depicted in FIG. 3, for a vendor to use the security system 307, the security system establishes an account and agreement with a given vendor 301. A consumer, who has previously set up an account on the secure website by providing the security system with at least the consumer's credit card numbers and thumbprints or fingerprints. At the point of sale 308, the amount of the consumer's purchases is calculated and the consumer places a finger or thumb on a biometric reader to begin the transaction. The consumer indicates which credit card or debit card is to be used. The vendor's computer system transmits the request to the security system. After matching the finger or thumb, the security system transmits the request for payment to the respective credit card company. The credit card company remits the payment electronically to the security system 302. The security system then remits the payment to the vendor on behalf of the credit card company 303. The security system can reconcile accounts 309. The accounts are reconciled daily maintaining a zero balance on the secure website 304. In an embodiment, the security system maintains a transaction log for 60 days 305. In an embodiment, the credit card company maintains a record of transactions and provides the consumer with account statements 306.

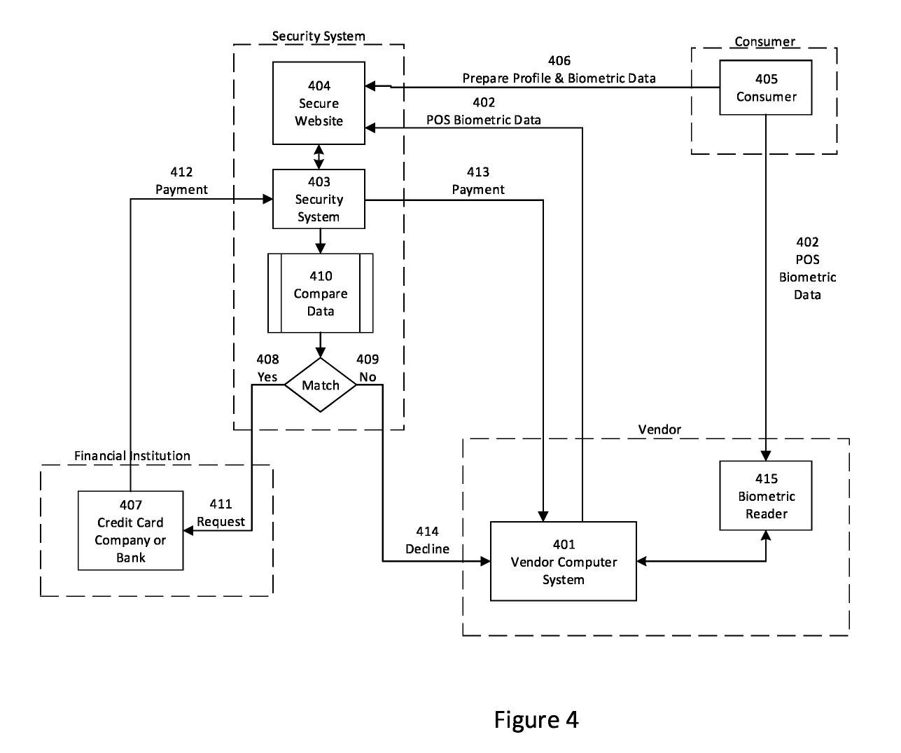

As depicted in FIG. 4, a consumer 405 prepares a profile and provides profile biometric data 406 with the profile. When a consumer wants to pay a vendor, the consumer provides point of sale biometric data 402 through the biometric reader 415 connected to the vendor computer system 401. The point of sale (P.O.S.) biometric data 402 is sent to the secure website 404. The security system 403 performs a comparison 410 of the point of sale biometric data 402 from the biometric reader 415 on the vendor computer system 401 with the profile biometric data 406. If the biometric data is a match 408, a request for payment 411 is sent to the credit card company or bank 407 by the security system 403. The credit card company or bank 407 remits payment 412 to the security system 403. The security system 403 then remits payment 413 to the vendor computer system 401. If the point of sale biometric data 402 does not match 409, the security system 403 declines payment 414 the vendor computer system 401.

In an embodiment, a computer network transmits a signal from the biometric reader to the security system comprising at least one of the group consisting of biometric data and the amount of the transaction. In an embodiment, the signal comprises the biometric data and the amount of the transaction. In an embodiment, the biometric reader is in communication with the vendor computer system. In an embodiment, the security system comprises a computer network. In an embodiment, the security system comprises a secure website. In an embodiment, a computer compares the biometric data present in the consumer's profile to the biometric data transmitted in the signal from the biometric reader. In an embodiment, the computer comparing the biometric data is part of a computer network.

In an embodiment, the consumer will still receive their reward points from their credit card company. The purchase is being made using the consumer's account with the request for payment and the actual payment traveling through the security system.

In an embodiment, the consumer can get cash back from the transaction by telling the vendor to add that amount to the total purchases.

In an embodiment, the consumer can use the fingerprint security system at an automated teller machine that is capable of fingerprint scanning.

In an embodiment, the credit/debit card company can be instructed to request approval by text or telephone if a transaction is requested by use of an actual credit/debit card instead of a fingerprint.

In an embodiment, biometrics other than a fingerprint can be used. In an embodiment, the biometric can include, but is not limited to, at least one from the group consisting of a handprint, retinal scanning, facial recognition, vein scanning, and ear scanning. In an embodiment, a biometric reader can read at least one biometric from the group consisting of a fingerprint, handprint, retinal scan, facial recognition, vein scan, and ear scan. In an embodiment, various ridges and valleys on a palm are located and compared to a palm scan on file at the secure website. In an embodiment, the consumer provides a retinal scan when setting up his/her profile. The retinal scanner plots the pattern of blood vessels. At the point of sale, the consumer provides a retinal scan and the pattern of blood vessels is compared to the pattern of blood vessels in the retinal scan on file. In an embodiment, the consumer provides a facial scan using a webcam. The distance between various points on the face is determined. At the point of sale, the consumer provides a facial scan and the distance between various points on the face is compared to the distances in the profile.

In an embodiment, if someone uses the account numbers of another person and sets up a security system profile with the other person's account numbers and their fingerprints, the account holder can become aware of the problem by reviewing their credit card statement.

Any device capable of scanning a fingerprint can be used as a biometric reader. In an embodiment, a biometric reader for fingerprints can be a dedicated fingerprint reader or a smart phone or tablet with thermal fingerprint recognition capability (e.g., iPhone, iPad, or Android device).

Any device capable of scanning a particular biometric can be used as a reader. In an embodiment, a dedicated handprint, facial, retinal, vein, or ear scanner can be used. In an embodiment, fingerprint readers can be a smart phone or tablet with scanning capability (e.g., iPhone, iPad, or Android device). In an embodiment, the scanner can be a camera or smart phone or tablet with camera capability (e.g., iPhone, iPad, or Android device).

Types of vendors where the security system can be used include, but are not limited to, online merchants, department stores, grocery stores, drug stores, service stations, restaurants, clubs or bars, and any establishment that accepts credit or debit card payments. The security system could also be used for food stamp use with the consumer's food stamp account in place of the credit or debit card company.

In an embodiment, a consumer can make an online purchase by using their smart phone or tablet as a biometric reader. In an embodiment, a software application can be prepared and offered for download to smart phones or tablets. In an embodiment, the software application serves to provide the amount of the transaction and choice of credit or debit cards to the consumer. In an embodiment, the software application can send the biometric data, choice of credit or debit card, and biometric data to the security system.

In an embodiment, the security system could be used to pay an individual. In an embodiment, the individual has an account with the secure website that includes his/her bank account information.

In an embodiment, the consumer can scan his/her fingerprint on his/her smartphone or tablet, the dollar amount request and fingerprint would be transmitted to the security system; the fingerprint would be compared to the fingerprint on file on the security system; if the fingerprints match, the dollar amount request will be sent to the credit card company; the credit card company would remit the payment to the security system; the security system would remit the payment to party to be paid.

### EXAMPLES

### Example 1

When a consumer wants to make a purchase at a participating vendor, the consumer will state he/she wants to use the security system. The consumer will place their thumb or finger on the biometric reader linked to the security system which identifies that consumer as a member in the security system.

Once the member is identified in the security system, the logos for the credit or debit cards they have on file in the secure system appear on the screen, such as Visa, MasterCard, American Express, Discover, or a bank name for a debit card. The member will touch the logo on the screen to choose the form of payment. The security system will place the charge and receive authorization for payment from the credit card company or bank.

The member will verify the dollar amount and card chosen on the screen. The payment will be processed by the security system through the card or account they have chosen and will be remitted to the vendor. The member can also request cash back if using a debit card.

Credit and debit card information, account numbers or pins will not be provided to the vendor. The credit/debit card company will be charged through the security system on behalf of vendor so the vendor will still be responsible for paying the user fees, if any, to the credit card company, and the consumer can still earn points from the credit card company for purchases and promotions. The consumer will not have to carry credit cards, debit cards, or cash or enter a personal identification number at the vendor.

All of the methods and systems disclosed and claimed herein can be performed without undue experimentation in light of the present disclosure. While the methods of this disclosure have been described in terms of preferred embodiments, it will be apparent to those of skill in the art that variations can be applied to the systems, compositions, devices, and in the steps or in the sequence of steps of the methods described herein without departing from the concept, spirit and scope of the disclosure. More specifically, it will be apparent that certain related devices can be substituted for the devices described herein while the same or similar results would be achieved. All such similar substitutes and modifications apparent to those skilled in the art are deemed to be within the spirit, scope and concept of the disclosure as defined by the appended claims.

1. A system to prevent fraud comprising
a secure website at which a consumer prepares a profile comprising biometric data;
a vendor computer system transmitting an amount of a consumer transaction to
a biometric reader;
a biometric reader in communication with the vendor system displaying the amount of the consumer transaction to the consumer, wherein when the consumer sees the amount of the consumer transaction, the consumer approves payment for the consumer transaction by providing biometric data to the biometric reader;
wherein the vendor computer system does not obtain a credit card number of the consumer;
a first computer network transmitting a first signal comprising biometric data from the biometric reader to a security system;
the security system comparing the biometric data present in the profile to the biometric data transmitted in the first signal;
a second computer network transmitting a second signal from the security system to a financial institution, wherein the second signal is requesting payment for the amount of the consumer transaction;
a third computer network transmitting a third signal comprising payment for the consumer transaction from the financial institution to the security system if the financial institution approves the charge; and
a fourth computer network transmitting a fourth signal comprising payment for the consumer transaction from the security system to the vendor computer system, wherein the security system is not part of a financial institution.

2. The system of claim 1 wherein the biometric data is a vein scan.

3. The system of claim 1 wherein the vendor computer system comprises one or more computers.

4. The system of claim 1 wherein the second signal comprises the amount of the consumer transaction.

5. The system of claim 1 wherein the financial institution is a credit card company.

6. The system of claim 1 wherein the financial institution is a bank.

7. The system of claim 1 wherein the vendor computer system comprises a point-of-sale terminal.

8. The system of claim 1 wherein the vendor computer system comprises an automatic teller machine.

9. The system of claim 1 wherein the profile comprises credit card numbers.

10. The system of claim 1 wherein the biometric reader is selected from a group consisting of heat sensitive and light sensitive.

11. A method to prevent fraud comprising
preparing a profile on a secure website, wherein the profile includes biometric data;
attempting to obtain goods or money from a vendor;
transmitting the amount of goods or money to be obtained from a vendor computer system to a biometric reader;
placing a body part comprising the biometric data in range of the biometric reader;
transmitting a biometric data to a security system;
transmitting a signal comprising biometric data from the security system to a financial institution;
comparing of the signal biometric data to the biometric data present in the profile;
transmitting a signal from the financial institution to the security system comprising payment for the transaction; and
transmitting a signal from the security system to the vendor computer system comprising payment.

12. The method of claim 11 wherein the biometric data is a fingerprint.

13. The method of claim 11 wherein the vendor computer system comprises one or more computers.

14. The method of claim 11 wherein the financial institution is a credit card company.

15. The method of claim 11 wherein the financial institution is a bank.

16. The method of claim 11 wherein the vendor computer system includes a point-of-sale terminal.

17. The method of claim 11 wherein the vendor computer system comprises an automatic teller machine.

18. The method of claim 11 wherein the profile includes credit card numbers.

19. The method of claim 11 wherein the biometric reader is heat sensitive.
